(19) United States
(12) Patent Application Publication
(10) Pub. No.: US 2009/0282747 A1
(43) Pub. Date: Nov. 19, 2009

(54) GRAIN BIN WITH PERSON ELEVATOR

(76) Inventors: Richard J. Epp, Fiske (CA); Dwayne S. Epp, Fiske (CA)

Correspondence Address: ADE & COMPANY INC., 2157 Henderson Highway, WINNIPEG, MB, R2G1P9, CA

(21) Appl. No.: 12/463,832

(22) Filed: May 11, 2009

Related U.S. Application Data
(60) Provisional application No. 61/053,066, filed on May 14, 2008.
(60) Provisional application No. 61/149,393, filed on Feb. 3, 2009.

(51) Int. Cl. B65D 90/00; B65D 88/02; B66B 9/00; B61B 5/00; B65D 88/08

(52) U.S. Cl. 52/20; 187/239; 104/127

(57) ABSTRACT

A grain bin has a vertical side wall and an inclined roof and a personal lift system is provided for lifting a person to the roof which comprises an upstanding support post or posts tied to the vertical wall with a pulley and cable for lifting a cage containing the person. A counterweight is provided allowing the power for lifting to be provide by the person pulling on the cable. A rail system is provided which allows the cage to move from a lift portion of the rail system at the support post onto the rail to travel horizontally to one or more bins arranged in a row.

This application claims the benefit under 35 U.S.C. 119 of the filing dates of Provisional Application No. 61/053,066 filed May 14, 2008 and Provisional Application 61/149,393 filed Feb. 3, 2009.

This invention relates to a grain bin with a novel arrangement for a person to access the top opening of the bin and to the apparatus per se for use with the grain bin.

### BACKGROUND OF THE INVENTION

It is commonly necessary for an operator to climb to the top of a grain bin during filling particularly but also at other times to observe the filing process. Conventionally this is done by the person climbing a ladder along the side wall and onto the inclined roof. As grain bins are dangerously high, the climbing is dangerous and undesirable. Attempts have been made to make the climbing less dangerous by enclosing the ladder in a cage so that the operator is less likely to fall directly from the ladder to the ground but even with these arrangements the climbing is undesirable. Up to now, no solution for this has been proposed leaving farm operators open to the considerable risks of their profession without any suitable reduction in that risk.

### SUMMARY OF THE INVENTION

It is one object of the invention to provide a novel arrangement for a person to access the top opening of the bin and.

According to one aspect of the invention there is provided an apparatus for scaling a grain bin, where the grain bin has a vertical side wall, an inclined roof converging upwardly and inwardly from the top of the vertical side wall, and a top opening of the grain bin at a top of the inclined roof, the apparatus comprising:

an upstanding support structure having a bottom end for placement on the ground at one side of the grain bin and a top end at a height above the top of the vertical side wall and aligned with the inclined roof;

at least one tie member for connecting the support structure to the vertical wall;

a pulley at an upper end of the support structure;

a cable extending over the pulley;

a cage shaped and arranged to contain a person within the cage with a cage floor on which the person can stand;

at least one cage opening on the cage allowing entrance of the person into the cage and exit of the person from the cage;

the cage being carried on the cable such that the cage can be raised along the support structure from a loading position with the cage floor at the ground to an exit position with the cage floor at the top of the vertical side wall and adjacent the bottom of the inclined roof;

the at least one opening being arranged such that the person so as to define an entry to the cage at the ground and so as to define an exit from the cage at the inclined roof.

Preferably there is provided a ladder carried by the inclined roof and extending upwardly to the top opening and arranged such that the a person stepping from the cage can step onto the ladder.

Preferably there is provided safety rails extending from the exit of the cage onto the roof arranged such that a person stepping from the cage at the roof can enter onto the ladder while holding the safety rails.

Preferably the safety rails are arranged at the cage so as to extend outwardly therefrom at a height such that a person stepping from the cage at the roof can step forwardly from the cage while standing and holding the safety rails.

Preferably the upstanding support structure is in the form of a post along side and parallel to the wall.

Preferably the post is tied to the wall at positions along its length.

Preferably the cage is shaped and arranged to contain a single person only.

Preferably there is provided a restriction assembly defining a safety zone at the ground for surrounding the cage, the assembly being arranged to prevent the entry of persons into the safety zone when the cage is elevated.

Preferably the safety zone is limited to a height such that it contains the cage only at the ground.

Preferably there is provided a counterweight having a weight closely approximating but less than the weight of the cage and the person and wherein the cable is arranged to be pulled manually by the person in the cage.

Preferably there is provided a safety latch to prevent movement of the cage.

Preferably there is provided a safety latch at the floor of the cage onto which the person must stand to allow movement of the cage.

Preferably there is provided a safety latch on the cable which is actuated when the cage reaches the top of the support structure.

Preferably the safety latch is manually releasable to allow the cage to lower.

Preferably the support structure comprises a hollow post and there is provided a counterweight located within the hollow post.

Preferably the counterweight includes guide rollers arranged to roll along an inner surface of the post.

Preferably the support structure comprises a post and the cage includes guide rollers arranged to roll along an outer surface of the post.

Preferably the support structure comprises a post and one side of the post includes a pair of flanges for connection to the wall of the bin.

Preferably the cage includes an entry door on one side for entry at ground level and a second door on another side for exit at the roof.

Preferably the upstanding support structure comprises a pair of parallel posts with the cage mounted so as to be supported on each of the posts.

Preferably there is provided a counterweight between the posts.

Preferably each of the posts comprises an inwardly facing C-channel with the cage having a pair of vertically spaced wheels running in the C-channel.

Preferably there is provide a guide rail system adjacent a top of the support structure for carrying at least a part of the cage horizontally from one bin to a next adjacent bin.

Preferably the cage includes a lift portion carried on the support structure and a carriage portion movable from the lift portion onto the guide rail system.

Preferably the guide rail system is arranged to span a plurality of bins in a row.

According to a second aspect of the invention there is provided a grain bin storage apparatus comprising:

a plurality of grain bins arranged side by side with each having a vertical side wall, an inclined roof converging upwardly and inwardly from the top of the vertical side wall and a top filling opening of the grain bin at a top of the inclined roof;

and a personal lift apparatus for lifting a person to the roof comprising:

an upstanding support structure having a bottom end on the ground at one side of at one of the grain bins and a top end at a height above the top of the vertical side wall and aligned with the inclined roof of said one grain bin;

at least one tie member for connecting the support structure to the vertical wall;

a cage shaped and arranged to contain a person within the cage with a cage floor on which the person can stand;

a lift system for lifting the cage such that the cage can be raised along the support structure from a loading position with the cage floor at the ground to an exit position with the cage floor at the top of the vertical side wall and adjacent the bottom of the inclined roof;

and a guide rail system adjacent a top of the support structure for carrying at least a part of the cage horizontally from said one bin to a next adjacent bin.

### BRIEF DESCRIPTION OF THE DRAWINGS

One embodiment of the invention will now be described in conjunction with the accompanying drawings in which:

FIG. 1 is a top plan view of a grain bin including a personal elevator according to the present invention.

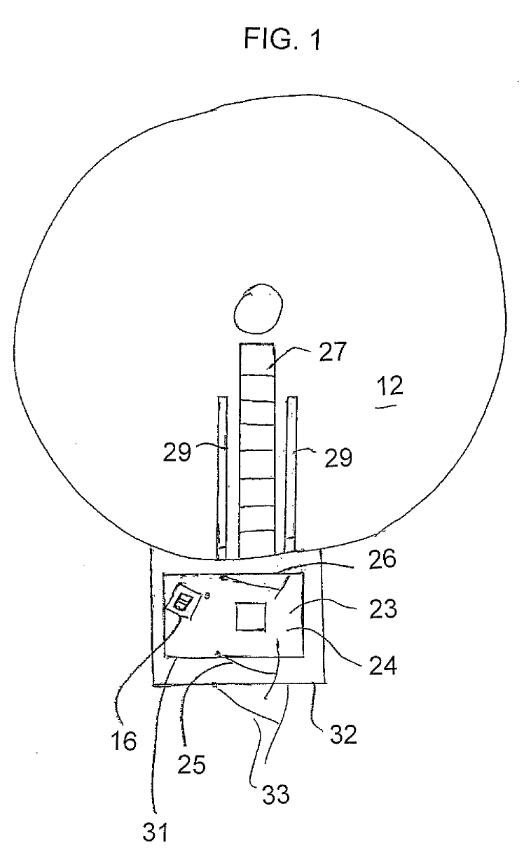

FIG. 2 is a top plan view on an enlarged scale of the personal elevator of FIG. 1.

FIG. 3 is a side elevational view of the personal elevator of FIG. 1.

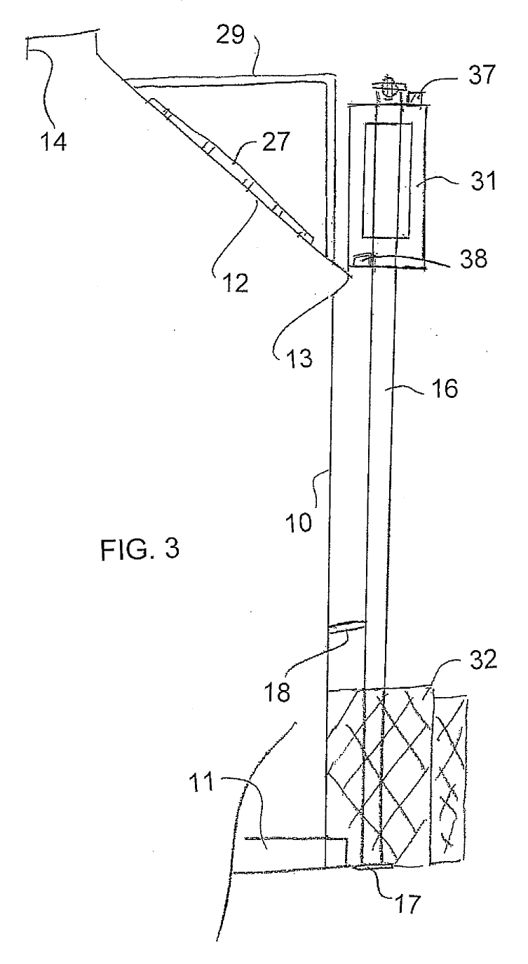

FIG. 4 is a side elevational view of a modified version of the personal elevator of FIG. 1 including an additional transfer arrangement for movement between a row of bins.

FIG. 5 is a front elevational view of the personal elevator of FIG. 4.

FIG. 6 is a top plan view of the personal elevator of FIG. 4.

In the drawings like characters of reference indicate corresponding parts in the different figures.

### DETAILED DESCRIPTION

A grain bin which is circular in plan has a cylindrical vertical side wall standing on a base 11 with an inclined conical roof converging upwardly and inwardly from the top of the vertical side wall at an eve 13. At the top of the roof is provided a top opening of the grain bin at a top of the inclined roof for filing and service.

The apparatus for scaling the bin replaces conventional ladders and includes an upstanding support structure or post 16 having a bottom end for placement on the ground at one side of the grain bin and a top end at a height above the top of the vertical side wall 10 and aligned with the inclined roof 12.

The post is connected to the wall 10 by at least one tie member 18. In the embodiment shown the post is formed as an open column with one side open at 19 and defining a pair of flanges along the length of the post for connection to the wall 10 by bolts 20.

A pulley 21 is located at an upper end of the post 16 with a cable 22 extending over the pulley and extending at one end to a cage 23 shaped and arranged to contain a person within the cage with a cage floor 24 on which the person can stand. The cage has a first cage door 25 on the side of the cage facing away from the bin allowing entrance of the person into the cage at the ground. The same cage door can be arranged to allow the exit of the person from the cage at the roof 12, or a second door 26 can be provided on the inside of the cage.

The cage is carried on the cable such that the cage can be raised along the support structure from a loading position with the cage floor at the ground to an exit position with the cage floor 24 at the top of the vertical side wall and adjacent the bottom of the inclined roof.

The exit door exits onto a ladder 27 carried by the inclined roof and extending upwardly from the bottom of the roof to the top opening and arranged such that a person stepping from the exit door of the cage can step onto the ladder.

In order to assist the person while standing in the cage in exiting onto the inclined ladder there are provided a pair of safety rails 29 extending from the exit of the cage onto the roof arranged such that a person stepping from the cage at the roof can enter onto the ladder while holding the safety rails. The safety rails are arranged at the cage so as to extend outwardly therefrom at a height such that a person stepping from the cage at the roof can step forwardly from the cage while standing and holding the safety rails. The safety rails can be attached to the post or to the roof but allow the person to stand as they exit and to walk up the inclined ladder of the roof while holding the rails.

The cage is shaped and arranged to contain a single person only. The cage has a fence or wall 31 around so that the person when inside is fully confined and cannot fall.

There is also provided a restriction assembly or fence 32 defining a safety zone at the ground only for surrounding the cage, the assembly being arranged to prevent the entry of persons into the safety zone when the cage is elevated. The fence 32 has a door 33 normally locked with can be opened to allow the person to enter through the doors 33 and 25 into the cage. The remainder of the post is open so that the fence 31 is limited to a height such that it contains the cage only at the ground to prevent a person entering into the cage area as the cage is descending to prevent possibility of injury.

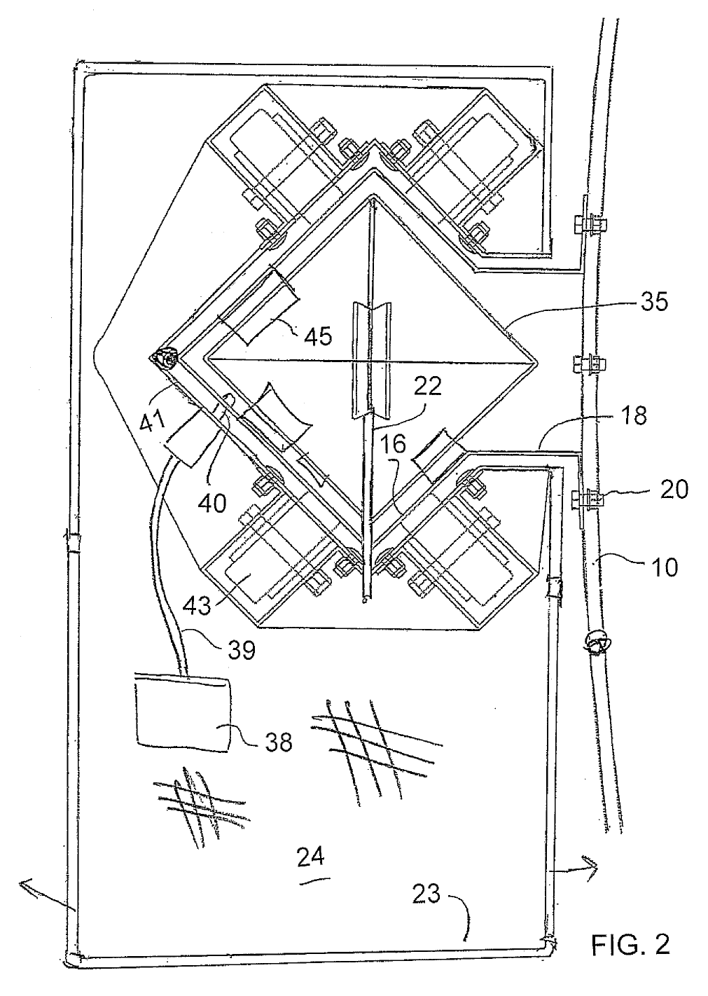

The cage is supported by a counterweight attached to the other end of the cable 22 (FIG. 2) having a weight closely approximating but less than the weight of the cage and the person. The cable is arranged and located to be pulled manually by the person in the cage to avoid the expense, danger and complexity of motors. As there is only a slight difference in weight between the cage and person at one end and the counterweight at the other end, ion the event that the cable is released or the person become incapacitated, the cage will fall only slowly with little possibility of damage.

In order to prevent the cage falling from the top unintentionally there is provided a safety latch 37 engaging the cable to prevent movement of the cage. This can be activated by the cage reaching the top of the post or the bottom of the post so that the cable is then latched and only released for further movement when manually grasped by the user.

There is provided a second safety latch 38 at the floor of the cage onto which the person must stand to allow movement of the cage. This operates a cable 39 to release a pin 40 engaging through a sleeve 41 into the wall of the post.

As best shown in FIG. 2, the hollow post carries a sleeve 41 surrounding the post and running on the post as a guide using an array of guide rollers 43 attached to the sleeve and rolling on the post. The counterweight 35 is located within the hollow post and runs on rollers 45.

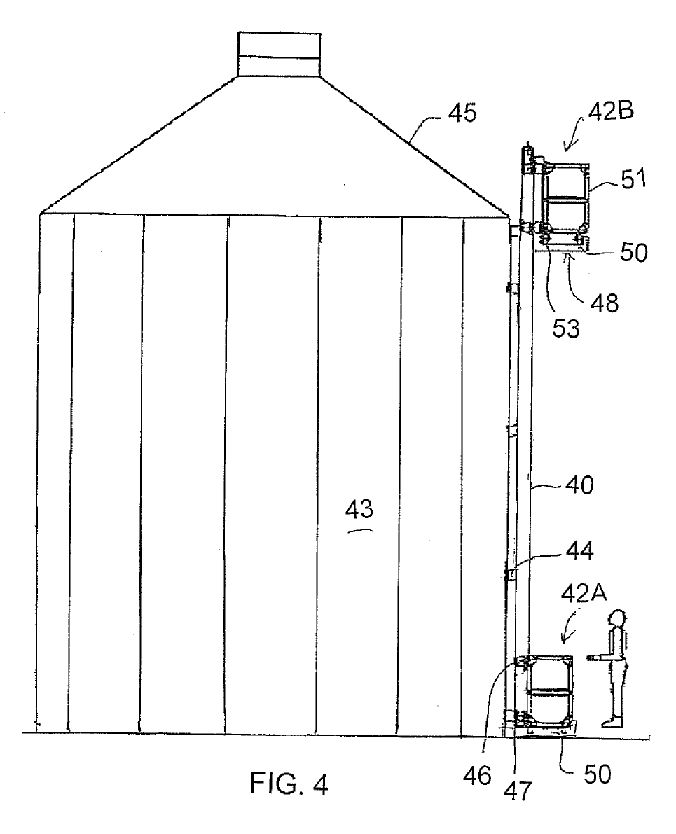

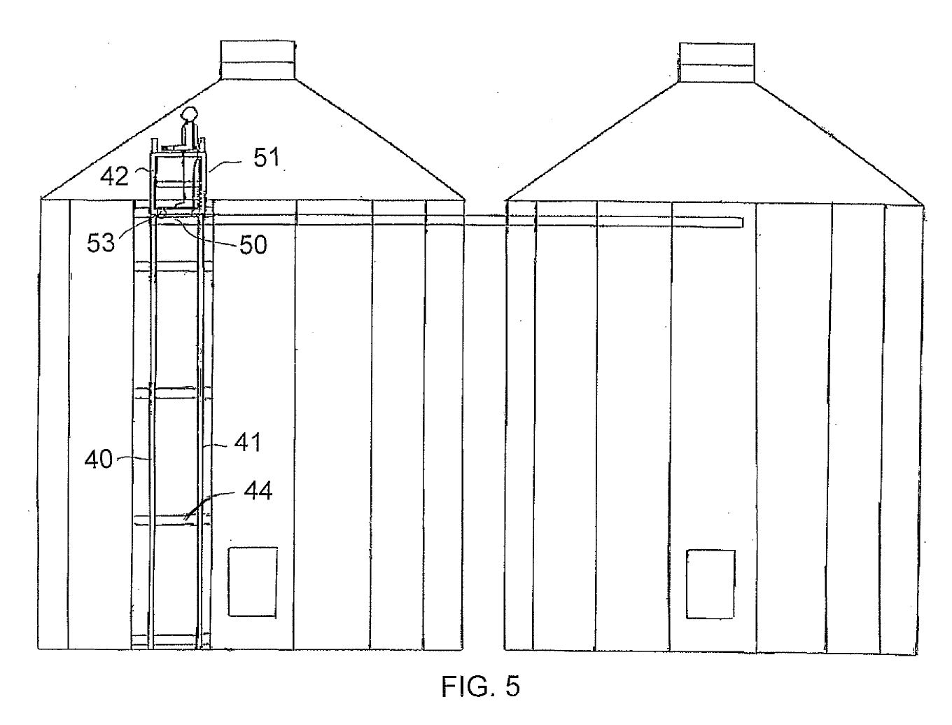

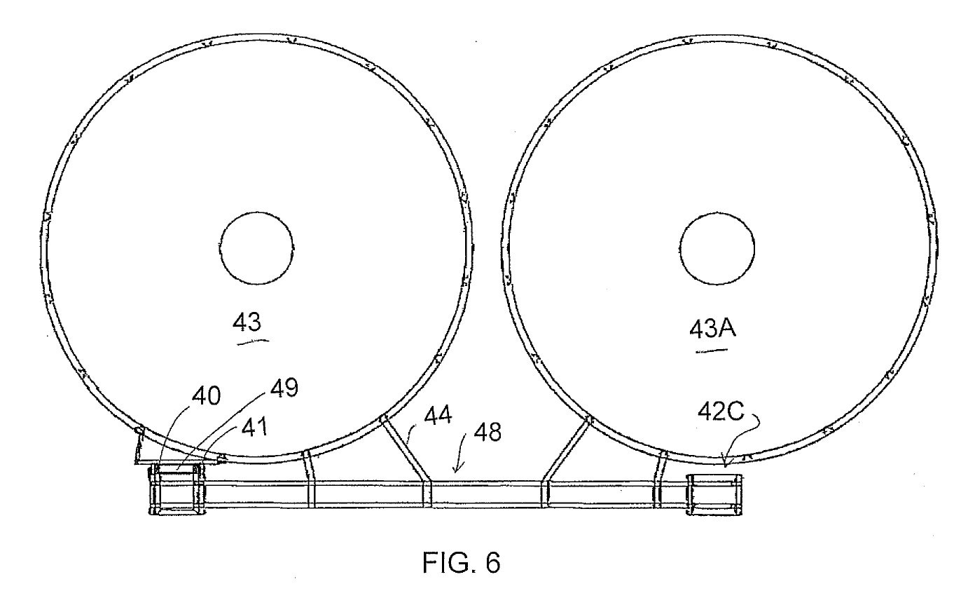

Other arrangements of post and support for the cage on the post can be used. For example in FIGS. 4, 5 and 6 is shown an arrangement where the upstanding support structure comprises a pair of parallel posts 40 and 41 with the cage 42 mounted so as to be supported on each of the posts. The posts stand along side one bin 43 and are tied to the bin wall along the outside of the bin at spaced positions along the height of the pots by connecting ties 44. The posts stand upwardly to a height above the top of the bin wall to a position aligned with the roof 45. Each of the posts comprises an inwardly facing C-channel with the cage having a pair of vertically spaced wheels 46, 47 running in the C-channel so that the cage is supported on four wheels spaced at corners of a rectangle between the posts. The cage is cantilevered outwardly from the posts away from the bin.

A pulley is provided at the top of each post and a cable is wrapped around from the cage on one side to a counterweight 49 between the posts. The counterweight closely balances the weight of the cage and operator so that the operator can pull the cage and himself upwardly to the top and can lower himself to the ground when complete.

The system includes the safety systems and locks previously described but not shown for convenience.

In this embodiment there is provide a guide rail system 48 adjacent a top of the support structure for carrying at least a part of the cage horizontally from one bin to a next adjacent bin. The whole cage can be disconnected from the lift system and transferred onto the guide rails to move from the top of the first bin to the top of a second bin 43A.

However in the preferred arrangement shown, the cage includes a lift portion 50 carried on the support structure and a carriage portion 51 movable from the lift portion onto the guide rail system. The carriage portion includes four wheels 53 at the bottom of the carriage portion for rolling along the guide rail system. In the first lifting mode, the four wheels sit on the lifting portion 50 and are lifted thereby. Suitable locking clamps or pins are provided to hold the carriage position in place to prevent it toppling or the guide rail system may hold the carriage portion in place by locking the wheels into the rail system in the form of a mono-rail system.

When the carriage portion reaches the top of the posts, the operator can step out onto the roof of the bin 43 to carry out inspections and maintenance as required. When that is complete, the operator can release the locking systems holding the carriage portion 51 in place on the lifting system and can move the carriage portion onto the mono-rail system from the lifting portion 50 onto the rail 48 which are aligned to allow the transfer. The guide rail system is arranged to span a plurality of bins in a row so that the rail system moves the operator from the first bin to the next and to the next as required. At each bin the carriage portion 51 is in position to allow the operator to step out from the carriage onto the roof of the bin. Each bin roof has a ladder and hand rails to guide the operator as he steps onto the roof. The operator steps from the rear of the cage which includes a closure panel or door to prevent falling during the transfer along the rail.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A grain bin comprising;
a vertical side wall;
an inclined roof converging upwardly and inwardly from the top of the vertical side wall;
a top filling opening of the grain bin at a top of the inclined roof;
and a personal lift apparatus for lifting a person to the roof comprising:
an upstanding support structure having a bottom end on the ground at one side of the grain bin and a top end at a height above the top of the vertical side wall and aligned with the inclined roof;
at least one tie member connecting the support structure to the vertical wall;
a pulley at an upper end of the support structure, a cable extending over the pulley;
a cage shaped and arranged to contain the person within the cage with a cage floor on which the person can stand;
at least one cage opening on the cage allowing entrance of the person into the cage and exit of the person from the cage;
the cage being carried on the cable such that the cage can be raised along the support structure from a loading position with the cage floor at the ground to an exit position with the cage floor at the top of the vertical side wall and adjacent the bottom of the inclined roof,
the at least one cage opening being arranged so as to define an entry to the cage at the ground and so as to define an exit from the cage at the inclined roof.

2. The grain bin according to claim 1 wherein there is provided a ladder carried by the inclined roof and extending upwardly to the top opening and arranged such that a person stepping from the cage can step onto the ladder.

3. The grain bin according to claim 2 wherein there is provided safety rails extending from the exit of the cage onto the roof arranged such that a person stepping from the cage at the roof can enter onto the ladder while holding the safety rails.

4. The grain bin according to claim 2 wherein the safety rails are arranged at the cage so as to extend outwardly therefrom at a height such that a person stepping from the cage at the roof can step forwardly from the cage while standing and holding the safety rails.

5. The grain bin according to claim 1 wherein the upstanding support structure is in the form of at least one post along side and parallel to the wall.

6. The grain bin according to claim 5 wherein the at least one post is tied to the wall at positions along its length.

7. The grain bin according to claim 1 wherein the cage is shaped and arranged to contain a single person only.

8. The grain bin according to claim 1 wherein there is provided a restriction assembly defining a safety zone at the ground for surrounding the cage, the assembly being arranged to prevent the entry of persons into the safety zone when the cage is elevated.

9. The grain bin according to claim 8 wherein the safety zone is limited to a height such that it contains the cage only at the ground.

10. The grain bin according to claim 1 wherein there is provided a counterweight having a weight closely approximating but less than the weight of the cage and the person and wherein the cable is arranged to be pulled manually by the person in the cage.

11. The grain bin according to claim 1 wherein there is provided a releasable safety latch to prevent movement of the cage from the loading position and from the exit position.

12. The grain bin according to claim 11 wherein the safety latch is located at the floor of the cage onto which the person must stand to allow movement of the cage.

13. The grain bin according to claim 1 wherein the support structure comprises a hollow post where the cage includes guide rollers arranged to roll along an outer surface of the post and wherein there is provided a counterweight located within the hollow post.

14. The grain bin according to claim 1 wherein the cage includes an entry door on one side for entry in the loading position and a second door on another side for exit in the exit position.

15. The grain bin according to claim 1 wherein the upstanding support structure comprises a pair of parallel posts with the cage mounted so as to be supported on each of the posts with a counterweight located between the posts.

16. The grain bin according to claim 15 wherein each of the posts comprises an inwardly facing C-channel with the cage having a pair of vertically spaced wheels running in the C-channel.

17. The grain bin according to claim 1 wherein there is provide a guide rail system adjacent a top of the support structure for carrying at least a part of the cage horizontally from one bin to a next adjacent bin.

18. The grain bin according to claim 17 wherein the cage includes a lift portion carried on the support structure and a carriage portion movable from the lift portion onto the guide rail system.

19. The grain bin according to claim 18 wherein the guide rail system is arranged to span a plurality of bins in a row.

20. A grain bin storage apparatus comprising:
a plurality of grain bins arranged side by side with each having a vertical side wall, an inclined roof converging upwardly and inwardly from the top of the vertical side wall and a top filling opening of the grain bin at a top of the inclined roof;
and a personal lift apparatus for lifting a person to the roof comprising:
an upstanding support structure having a bottom end on the ground at one side of at one of the grain bins and a top end at a height above the top of the vertical side wall and aligned with the inclined roof of said one grain bin;
at least one tie member for connecting the support structure to the vertical wall;
a cage shaped and arranged to contain a person within the cage with a cage floor on which the person can stand;
a lift system for lifting the cage such that the cage can be raised along the support structure from a loading position with the cage floor at the ground to an exit position with the cage floor at the top of the vertical side wall and adjacent the bottom of the inclined roof;
and a guide rail system adjacent a top of the support structure for carrying at least a part of the cage horizontally from said one bin to a next adjacent bin.

21. The apparatus according to claim 20 wherein the cage includes a lift portion carried on the support structure and a carriage portion which sits on the lift portion and is movable from the lift portion onto the guide rail system for movement from the support structure along the guide rail system.

22. The apparatus according to claim 20 wherein the guide rail system is arranged to span a plurality of bins in a row.
